(19) United States
(12) Patent Application Publication
(10) Pub. No.: US 2024/0262973 A1
(43) Pub. Date: Aug. 8, 2024

(54) RECYCLING METHOD

(71) Applicant: ALPLA WERKE ALWIN LEHNER GMBH & CO. KG, Hard (AT)

(72) Inventors: Michael Heyde, Bergisch Gladbach (DE); Christiane Horn, Dornbirn (AT); Bryan-Cody Borchers, Geilenkirchen (DE)

(21) Appl. No.: 18/567,000

(22) PCT Filed: Jun. 2, 2022
(86) PCT No.: PCT/EP2022/065039

§ 371 Date: Dec. 4, 2023

(30) Foreign Application Priority Data
Jun. 2, 2021 (CH) 00641/21

(51) Int. Cl. C08J 11/06; B29B 13/06; B29B 17/00; B29B 17/02; B29B 17/04; B29K 23/00; B29K 67/00

(52) U.S. Cl. CPC C08J 11/06; B29B 13/06; B29B 17/02; B29B 17/0412; B29B 2017/0015; B29B 2017/0203; B29B 2017/0279; B29K 2023/00; B29K 2067/003; C08J 2323/00; C08J 2367/02

(57) ABSTRACT

A method for recycling packaging wastes, referred to as first articles, made of PET or polyolefins (PO), that can be decolored in accordance with the “key-locker” principle, and second articles made of PET or PO, comprising the steps: (a) pre-sorting the first and second articles, (b) pre-washing the articles, (c) comminuting the articles to form flakes, (d) washing the articles, (e) dewatering and drying the flakes, (f) flake sorting, (g) extrusion, (h) solid-state polycondensation (SSP) in the case of PET wastes, or (i) decontamination in the case of PO wastes. The first articles are separated from the second articles by optical sorting and are decolored separate from the second articles in a decoloring step (j) by a reagent referred to as a “key.” The first decolored articles are temporarily stored (m) after step (j). After being stored, the first articles are fed to separate steps (g) and (h) or (i).

### CROSS-REFERENCE TO RELATED APPLICATIONS

This application is a national phase entry under 37 U.S.C. § 371 of PCT/EP2022/065039 filed Jun. 2, 2022, which claims priority to Swiss Patent Application No. CH00641/21 filed Jun. 2, 2021, the entirety of each of which is incorporated by this reference.

### FIELD OF THE INVENTION

The invention relates to a method for recycling packaging wastes made of polyethylene terephthalate (PET) or polyolefins (PO), which packaging wastes are referred to as first articles and can be decolored in accordance with the “key-locker” principle, and at least second articles made of PET or PO.

### PRIOR ART

EP 3 516 108 A1 discloses a method for producing a pigmented polymer material. In this method, the polymer is a mixture of a first polymer and a second polymer compatible with the first polymer. The second polymer is a masterbatch and has a binder for an aqueous pigment composition.

A method for decoloring a colored synthetic or non-synthetic polar polymer material is known from EP 3 770 208 A1. In this case, the colored polymer is exposed to a polar solvent. The polar solvent contains as a key reagent a polar decoloring agent for absorbing the color of the polymer.

Thus, these patent applications describe a technology for coloring plastics, wherein the colored plastic can be decolored with a key reagent or a “key” owing to the properties of the coloring agent. This technology shall be referred to as the “key-locker” principle in the context of this application.

If the colored plastic is to be recycled, there is a risk that the plastic parts colored according to the above method will “bleed” in a common fraction with differently colored plastic parts, i.e., release their color early or at points in the recycling process where this has a disruptive effect.

In addition, these colored plastics cannot currently be recycled separately, as the quantities in the return stream of the collected recyclables are still too small for economic operation. The colored plastics must therefore be recycled together with other plastics.

### Advantages of the Invention

The disadvantages of the described prior art are addressed by providing a recycling method in which optically sortable polymers, in particular the colored polymers described above, can be improved or decolored in an efficient, cost-effective and accordingly economical operation.

### SUMMARY OF THE INVENTION

The stated advantages are achieved in a method for recycling packaging wastes made of PET or PO, which packaging wastes are referred to as first articles and can be sorted according to a certain feature, in particular optically sorted, and at least second articles made of PET or PO, by means of the features indicated in the independent claims. Polyolefins include, for example, PP or HDPE. Developments and/or advantageous alternative embodiments form the subject-matter of the dependent claims.

The invention comprises that, in order to concentrate the first articles, the first articles are separated from the second articles by sorting and on which, after being separated, separately from the second articles, an improving step (j), in particular decoloring or depletion of contaminants, is carried out, the first sorted articles are temporarily stored in a store (m) after step (j), and after being stored, the first articles are fed to separate steps (g) and (h) or (i).

If a partial stream of a recycled product requires or enables a special treatment step that significantly improves the added value or the quality of the overall product, then the improving of the first articles has great potential with respect to the overall product. The partial stream of first articles has a feature that can be used in (optical) sorting to separate this partial stream. The treatment or improving step in question can be a decoloring concept or, more generally, the specific separation of contaminants that can only be found on a partial stream that can be uniquely assigned by sorting techniques. The contaminants can be, for example, special coatings on PET flakes.

By separating the first articles, these can be improved in an economical recycling method, since the main stream of the second articles is carried by the large quantity of at least second articles. The provision of a storage silo makes it possible to provide a sufficient quantity of flakes produced from first improved articles to allow the side stream to be operated continuously and, accordingly, profitably. If required, the storage silo can additionally be fed with suitable flakes from a separate recycling method. Therefore, the proportion of first articles can be low and the recycling method is still economical.

In a particular embodiment of the invention, the first articles can be decolored in accordance with the “key-locker” principle and the improving step is a decoloring step (j) in which the first articles are decolored by means of a reagent referred to as “key”. In the decoloring step, coloring substances are dissolved out of the first articles with the aid of the “key”. “Bleeding” of the first articles and the associated unwanted discoloration of the main stream of the second articles can be prevented by separating them. The use of the “key” to dissolve out coloring substances can be carried out in isolation from the main stream of the second articles.

In another embodiment of the invention, the first articles are separated from the second articles in method step (a). As a result, the first articles, for example bottles, can be removed from the main stream of the second articles as early as in the first method step, and the first articles can already be sorted and separately comminuted to form flakes. Bleeding of the first articles can be avoided by decoloring them before they are washed hot and intensively. A further advantage of sorting the uncomminuted articles is that a portion of the marking information is lost due to the grinding process. However, this information is fully present in the uncomminuted first articles. Optical sorting of the first articles is effected by color, shape, digital watermarks or marking substances. Sorting by shape, brand logos or digital watermarks is only possible for the uncomminuted first articles.

Expediently, the first articles are separated as flakes from the second articles in method step (f). The optical recognition rate for the first articles is particularly good in flake sorting.

It has proven useful if the optical sorting of the first articles can be effected by color, shape, digital watermarks or marking substances. Depending on how the first articles are marked, a high recognition rate can be achieved. The substance used as the “key” in the “key-locker” concept may also fulfill the function of the marker. Digital watermarks, marking substances or other passive detection features that are recognizable by means of non-visual spectroscopies (e.g., infrared spectroscopies, laser spectroscopy) can also be used as markers.

In another embodiment, the sorting of the first articles is optical sorting and can be affected by color, shape, digital watermarks or marking substances. This type of sorting ensures a high degree of separation of first and second articles.

In yet another embodiment, the store (m) is filled exclusively with first articles as flakes. This is advantageous if the recycling market is already penetrated to a relevant extent with first articles. As a result, the quantity of first articles in the recycling stream is sufficient to profitably operate a dedicated recycling line in a side stream. In the context of this application, relevant market penetration shall be understood to mean when the first articles account for more than or equal to 10 wt. % of the total stream.

If the recycling market has only a low market penetration at the beginning of the market introduction of the first articles, it is advantageous if the store (m) is filled with first articles as flakes and with natural-colored PO flakes or transparent PET flakes from an external recycling method (n). This allows a dedicated recycling line to be operated profitably in a side stream, even if the quantity of first articles is (still) low. In the context of this application, low market penetration is understood to mean when the first articles account for less than 10 wt. % of the total stream.

The invention also comprises that the decoloring step (j) is part of a bypass of the sorted first articles, which bypass is guided in a main stream of the first articles to the main stream of the second articles. By selectively branching off the bypass from the main stream of the second articles, the decoloring of the first articles can be performed economically, even if the quantities in the return stream of the collected recyclables are low. Any bleeding of the masterbatch that may occur is isolated in the bypass, which means that no damage can be caused to the main stream of the second articles. A low main stream of the first articles can be supplemented in the storage silo by feeding in a suitable additional flake stream.

Expediently, the decoloring step (j) is carried out in a decoloring bath. This allows the “key” to act efficiently to remove coloring substances from the first articles.

In a further embodiment of the invention, the decoloring step (j) can be operated either in a batchwise or continuous manner. If it is important to set an exact residence time, batch operation is advantageous. If this is less important, continuous operation, which requires less equipment and fewer containers than batch operation, is advantageous.

In a further embodiment of the invention, the first articles are ground into flakes before being fed to the decoloring step (j). The “key” can act particularly efficiently on the flakes to completely decolor them.

To meet specific purity requirements, a second washing step (b, k) can be provided in the bypass before or after the decoloring step (j). To improve the washing result, it is advantageous if the washing step after the decoloring is a second intensive washing step (k).

Advantageously, the second intensive washing step (k) is performed at a temperature between 50° C. and 90° C. and with a wash liquor with 0.5 to 5% NaOH.

In a further embodiment of the invention, a second drying step (l) is provided in the bypass, in which step the decolored flakes are dewatered. In the case of PO, mechanical dewatering is usually sufficient to remove moisture. The second drying step (l) enables the first articles sorted during the flake sorting (f) to be fed directly to the extrusion (g) after the decoloring.

In a further embodiment of the invention, a second drying step (l) is provided in the bypass, in which step the decolored flakes are dried. This (thermal) drying is necessary for first articles made of PET, since mechanical dewatering does not provide sufficient dehumidification for them. It has proven advantageous if the first washing step is a first intensive washing step (d). Intensification of the first washing step can be achieved by the choice of temperature (hot or cold wash), the number of washes in stages (single stage or multi-stage) the use of detergents, such as liquors, or one or more float-sink separations.

### BRIEF DESCRIPTION OF THE DRAWINGS

Further advantages and features become apparent from the following description of a plurality of exemplary embodiments of the invention with reference to the schematic representations. In the drawings, which are not true to scale:

FIG. 1: shows a flow diagram of a method for recycling PET or PO bottles as known from the prior art;

FIG. 2: shows a flow diagram showing a first embodiment for decoloring first articles integrated into the method according to FIG. 1, wherein the masterbatch is hot liquor-resistant and the first articles have a low market penetration (the low market penetration also applies to the embodiments of FIGS. 3 to 5);

FIG. 3: shows a flow diagram showing a second embodiment for decoloring first articles integrated into the method according to FIG. 1, wherein the masterbatch is also hot liquor-resistant;

FIG. 4: shows a flow diagram showing a third embodiment for decoloring first articles integrated into the method according to FIG. 1, wherein the masterbatch is not hot liquor-resistant,

FIG. 5: shows a flow diagram showing a fourth embodiment for decoloring first articles integrated into the method according to FIG. 1, wherein the masterbatch is also not hot liquor-resistant,

FIG. 6: shows a flow diagram showing a fifth embodiment for hot liquor-resistant masterbatches, wherein the first articles have a relevant market penetration (the relevant market penetration also applies to the embodiments of FIGS. 6 to 9);

FIG. 7: shows a flow diagram showing a sixth embodiment for hot liquor-resistant masterbatches;

FIG. 8: shows a flow diagram showing a seventh embodiment for hot liquor-resistant masterbatches, and

FIG. 9: shows a flow diagram showing an eighth embodiment for masterbatches that are also not hot liquor-resistant.

### DETAILED DESCRIPTION OF THE INVENTION

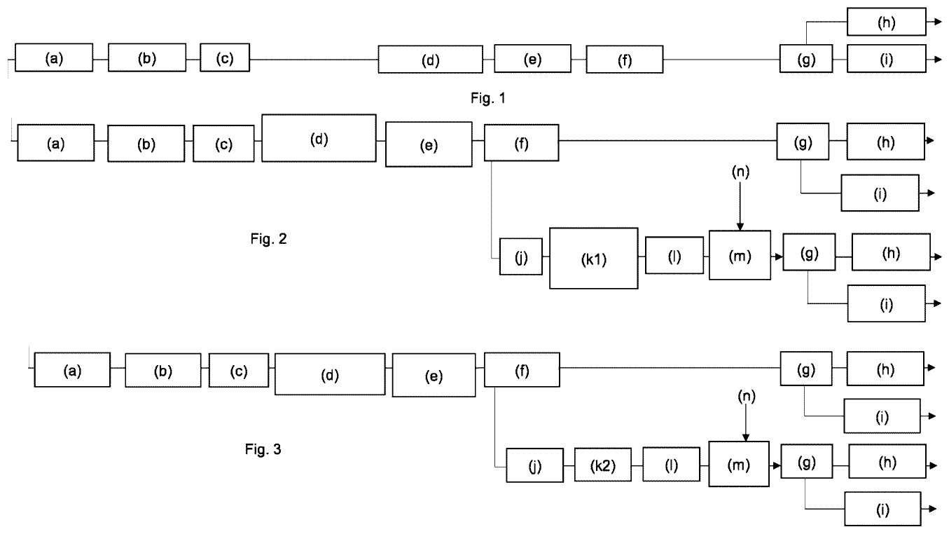

FIG. 1 illustrates a flow diagram of a known method for recycling PET or PO packaging wastes. The method comprises the following steps:
(a) pre-sorting the collected articles,
(b) pre-washing the articles,
(c) comminuting the articles to form flakes,
(d) washing the articles in a first washing step,
(e) dewatering and drying the flakes in a first drying step,
(f) flake sorting,
(g) extrusion and
(h) solid-state polycondensation (SSP) in the case of PET wastes, or
(i) decontamination in the case of PO wastes,

The pre-sorting (a) is an optical sorting operation by which articles are advantageously sorted by color from the mixed-color plastic waste products of one type of plastic (PO or PET), and other foreign materials are separated so that the target fraction is concentrated.

Steps (b) and (c) can be carried out in the following embodiment options:
1.) Single-stage comminution with pre-wash and/or post-wash or
2.) Two-stage comminution with pre-wash and/or intermediate wash and/or post-wash or
3.) Comminution by means of a wet or dry mill.

The first washing step (d) can be an intensive washing step. The intensification can be performed, for example, by means of a multi-hour intensive hot wash with liquor and detergents. After the SSP (h), the pellets made of rPET produced by extrusion (g) can, for example, be processed again to form containers, in particular bottles. The recycled pellets made of rHDPE can, for example, also be processed again to form containers, such as bottles.

The method according to the present invention is based on a partial stream of first articles of a recycled product requiring or enabling a special treatment step, also referred to as an improving step, which significantly enhances the added value or the quality of the overall product. The main stream accordingly consists of second articles which constitute the main volume stream of the product to be recycled. The partial stream of first articles has a feature that can be used in (optical) sorting to separate this partial stream. The relevant treatment step can be a decoloring concept or, more generally, the specific separation of contaminants that can only be found on a partial stream that can be uniquely assigned by sorting techniques. The contaminants can be, for example, special coatings on PET flakes.

An embodiment based on “smart coloring” technology is shown in FIGS. 2 to 5. In the method according to FIGS. 2 to 5, first and at least second articles made of PET or polyolefins (PO) are mixed in the packaging wastes which are fed as bales to step (a). The bales contain between 90 and 98 wt. % of packaging wastes of one type of plastic, i.e., PET or PO. The first articles can be decolored according to the “key-locker” principle, which principle is disclosed in EP 3 516 108 A1 and EP 3 770 208 A1. In this case, a color masterbatch is used whose color can be absorbed by a polar decoloring agent (reagent or “key”). This allows the first articles to be decolored by dissolving the coloring substances out of the first articles. This essentially improves the sustainability of plastic bottles and products.

With this principle, there is firstly a risk that the first articles will “bleed” in a common fraction with second articles, i.e., release their color early or at points in the recycling process where this has a disruptive effect. It is also disruptive if impurities also enter the decoloring bath.

Secondly, when a new technology is introduced, such as the “key-locker” principle, the quantities in the return stream of collected recyclables are still too small to be able to recycle them in a correctly sorted and at the same time economical manner.

The flow diagrams according to FIGS. 2 to 5 relate to methods when the first articles have a low market penetration. That is, the feed stream of packaging wastes has a low proportion of first articles. Typical quantities of first articles are below 10 wt. %.

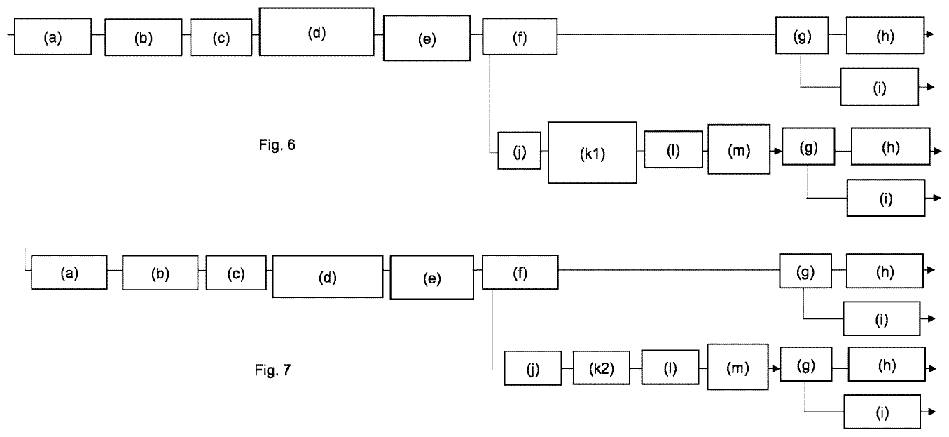

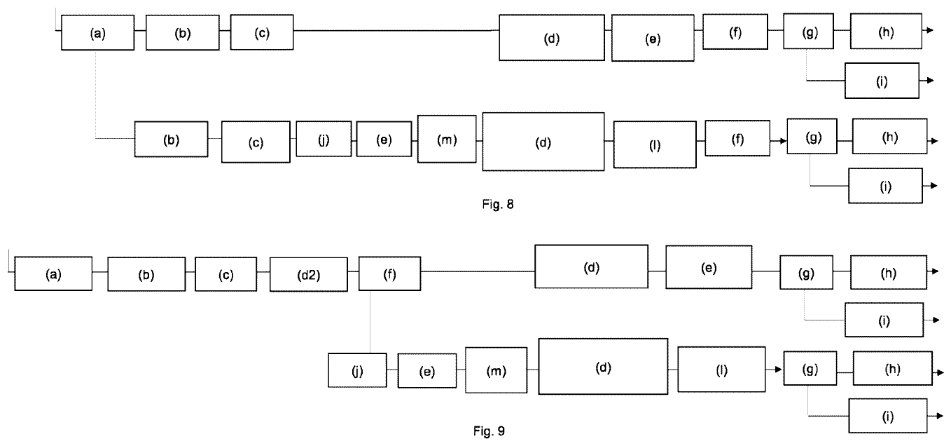

The flow diagrams according to FIGS. 6 to 9 show methods for a relevant market penetration of first articles. That is, the feed stream of packaging wastes has a relevant proportion of first articles. Typically, more than 10 wt. % of first articles are present in the recycling stream.

The flow charts according to FIGS. 2 and 3 are based on the idea of splitting the recycling stream in the processing phase, and thereby separating the first articles into a bypass or main stream of the first articles during the flake sorting (f) and collecting them separately in a storage silo (m) after the decoloring (j). This allows the recycling method to be operated economically even with low market penetration. Since the first articles present as flakes are separated from the main stream of the second articles only after the first washing step (d), the masterbatch must be hot liquor-resistant. Bleeding in the intensive washing step (d) is therefore not possible.

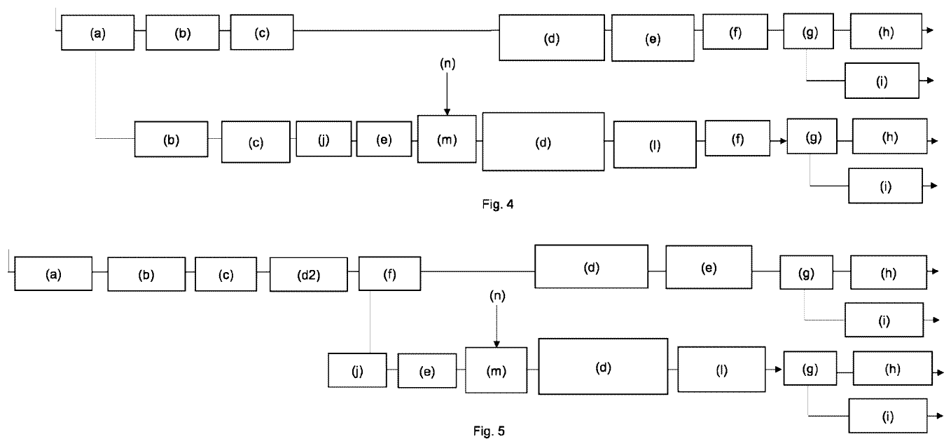

Optical sensors are used to concentrate the first articles in the bypass or the main stream of the first articles. It is conceivable to sort only by color, because the decolorable masterbatch is only used for one color; it is also possible to use characteristic shape features or brand logos that can be identified by image data processing. Finally, digital watermarks and marking substances can also be used. It is understood that identifying features, as described in the previous two sentences, can only be recognized in the case of uncomminuted first articles. Shape features, brand logos or digital watermarks can be used as sorting features only in methods according to flow charts of FIGS. 4 and 8.

In the bypass, a decoloring step (j) is provided in which the first articles present as flakes are decolored by the “key.” Advantageously, step (j) is carried out in a decoloring bath. The decolored flakes are fed to a post-wash (k1) as shown in FIG. 2. This post-wash can be carried out with cold water and without chemicals if the decolored flakes no longer require intensive cleaning.

According to FIG. 3, the post-wash can also be a second intensive washing step (k2) with caustic soda and cleaning substances. Since the flakes have already been decolored, they can no longer bleed in the intensive washing step (k2). After a second drying step (l), the decolored flakes are stored in the storage silo (m).

In case of low market penetration with first articles, it would be economically unviable to run the first articles through a separate extrusion (g) with subsequent steps (h) or (i). Therefore, the silo (m) is additionally filled with natural-colored PO flakes or transparent PET flakes from an external recycling method (n). The transparent flakes are processed according to the method shown in FIG. 1 up to the flake sorting (f). The separate extrusion (g) of the side stream can thus be operated economically with a sufficient quantity of flakes.

Also, the decolored and cleaned flakes of the first articles can be admixed to an already existing recycling method, which produces natural-colored or transparent flakes, in a storage silo (m) before the flake mixture is extruded.

FIGS. 4 and 5 show two embodiments for a low market penetration of first articles, in which the masterbatch is not hot liquor-resistant and would accordingly bleed during intensive hot washing with chemicals. In this case, the separation of the first articles from the main stream of the second articles is brought forward and the first washing step (d) takes place only after the storage silo (m) together with the natural-colored or transparent articles from a separate recycling method.

According to the method shown in FIG. 4, the first articles are already sorted as bottles out of the main stream of the second articles and the further method steps (b) and (c) are already carried out in the side stream. After the decoloring (j) and a first drying step (e), the decolored flakes are collected in the storage silo (m) and mixed with the additional natural-colored flakes so that a profitable quantity of flakes is present. Only after the storage silo (m) is the first washing step or intensive washing step (d) carried out, which is not critical because the first articles are already decolored. After a second drying step (l) and the flake sorting (f), the flakes can be extruded.

FIG. 5 also visualizes an embodiment of the recycling method for a low market penetration of first articles and a masterbatch that is not hot liquor-resistant. First, the usual method steps (a), (b) and (c) are performed. After a pre-washing step (d2), which is carried out gently to prevent discoloration of the masterbatch, the first articles are separated in the flake sorting (f). After a first drying step, the first articles present as decolored flakes are temporarily stored in the storage silo (m). As already stated above, the quantity of flakes is increased with the additional natural-colored flakes (n) so that a profitable quantity of flakes is present.

Only after this increase in quantity are the flakes intensively washed in the washing step or intensive washing step (d). In this step (d), the masterbatch can no longer bleed, since the first articles have already been decolored beforehand. After a second drying step (l), the flakes of the side stream are extruded separately from the main stream of the second articles. This separate extrusion (g) with the subsequent steps (h) or (i) is economically viable, since a sufficient quantity of flakes is present in the storage silo (m).

In principle, the embodiments according to FIGS. 6 to 9 are equivalent to those of FIGS. 2 to 5 in terms of the method sequence. However, these options are only applied when the recycling market has a sufficiently relevant market penetration of first articles. In that case, it is no longer necessary to supplement the first articles present as flakes in the storage silo (m) with a separate stream (n) of transparent flakes (PO) or natural-colored flakes (PET).

The invention allows several pre-sorting steps to be combined with a pre-washing step (b), (k), which enables concentration and precleaning of the portions to be provided for the decoloring bath (j). For this purpose, after the pre-sorting, the first articles are guided in a bypass or in a main stream of the first articles, which first articles are collected and temporarily stored in a storage silo (m) after being decolored.

Depending on market penetration, transparent PET flakes or natural-colored PO flakes can additionally be added to the storage silo (m) if required. These added flakes can already be intensively washed and dried when the first articles also enter the storage silo in a cleaned state. This ensures that there is a sufficient quantity of flake to make separate extrusion (g) for the first articles profitable. In principle, the approach is suitable for PO plastic products and for PET plastic products.

1. A method for recycling packaging wastes made of polyethylene terephthalate (PET) or polyolefins (PO), the packaging wastes forming first articles and second articles made of PET or PO, comprising the steps:
(a) pre-sorting the first and second articles,
(b) pre-washing the first and second articles,
(c) comminuting the first and second articles to form flakes thereof,
(d) washing the flakes of the first and second articles in a first washing step,
(e) dewatering and drying the flakes of the first and second articles in a first drying step,
(f) sorting the flakes of the first and second articles to separate the flakes of the first articles form the flakes of the second articles in order to concentrate the flakes of the first articles,
(g) extruding the flakes of the first and second articles, and
(h) performing solid-state polycondensation (SSP) in the case of PET flakes, or
(i) decontaminating in the case of PO flakes,
(j) performing an improving step by decoloring the flakes of the first articles or depleting contaminants from the flakes of the first articles,
(m) temporarily storing the flakes of the first articles in a store after performing step (j), and
(n) feeding the flakes of the first articles after step (m) to step (g) and then to steps (h) for PET flakes or step (i) for PO flakes.

2. The method according to claim 1, further comprising decoloring the first articles in step (j) in accordance with a “key-locker” principle wherein the first articles are decolored by a reagent referred to as a “key.”

3. The method according to claim 1, wherein the first articles are separated from the second articles in step (a).

4. The method according to claim 1, wherein the first articles are separated as flakes from the second articles in step (f).

5. The method according to claim 1, wherein the sorting of the first articles is optical sorting and can be affected by color, shape, digital watermarks or marking substances.

6. The method according to claim 1, wherein the store (m) is filled exclusively with first articles in the form of flakes.

7. The method according to claim 1, wherein the store (m) is filled with first articles in the form of flakes and with natural-colored PO flakes and, respectively, transparent PET flakes from an external recycling method (n).

8. The method according to claim 1, wherein the improving step (j) is part of a bypass of the sorted first articles, which bypass is guided in a main stream of the first articles to the main stream of the second articles.

9. The method according to claim 1, wherein the improving step (i) comprises the decoloring that is performed in a decoloring bath.

10. The method according to claim 9, wherein the decoloring step is operated either in a batchwise or continuous manner.

11. The method according to claim 1, wherein the first articles are ground into flakes before being fed to the improving step (j).

12. The method according to claim 8, further comprising a second washing step (k) in the bypass before or after the improving step (j).

13. The method according to claim 10, wherein the second washing step is a second intensive washing step.

14. The method according to claim 11, wherein the second intensive washing step is performed at a temperature between 50° C. and 90° C. and with a wash liquor with 0.5 to 5% NaOH.

15. The method according to claim 8, further comprising a second drying step in the bypass to dewater decolored flakes of the first articles.

16. The method according to claim 8, further comprising a second drying step is provided in the bypass, in which the decolored flakes of the first articles are dried.

17. The method according to claim 1, wherein the first washing step is an intensive washing step.
